(19) United States
(12) Patent Application Publication
(10) Pub. No.: US 2012/0202189 A1
(43) Pub. Date: Aug. 9, 2012

(54) RAPID, SEMI-AUTOMATED METHOD TO DETECT RESPIRATORY VIRUS INFECTED CELLS IN DIRECT SPECIMENS

(75) Inventors: Mark Carle Connelly, Doylestown, PA (US); Frank A.W. Coumans, Philadelphia, PA (US); Jimmy Page, McHenry, IL (US); Galla Chandra Rao, Junction, NJ (US); Joseph Jollick, JR., Athens, OH (US)

(73) Assignees: DIAGNOSTIC HYBRIDS, INC.; IMMUNIVEST CORPORATION

(21) Appl. No.: 12/450,846

(22) PCT Filed: Apr. 16, 2008
(86) PCT No.: PCT/US08/60489

§ 371 Date: Nov. 29, 2010

Related U.S. Application Data
(60) Provisional application No. 60/923,698, filed on Apr. 16, 2007.

(51) Int. Cl. G01N 21/17

(52) U.S. Cl. 435/5

(57) ABSTRACT

A novel cytometer system, methods and algorithms which provide a rugged, affordable and easy-to-use device in remote locations. All cells in a biological sample are fluorescently labeled, with target cells also magnetically labeled. Non-magnetically labeled cells are imaged for viability. Labeled sample is placed between two wedge-shaped magnets to selectively move the magnetically labeled cells for observation. A LED illuminates the cells and a CCO camera captures the images of the fluorescent light emitted by the target cells. Image analysis performed with a novel algorithm provides a cell count that can be related to the target cell concentration of the original sample.

### CROSS REFERENCE TO RELATED APPLICATIONS

This application is a non-provisional application, which is incorporated by reference herein and claims priority, in part, of U.S. Provisional Application No. 60/932,698, filed 16 Apr. 2007, now abandoned.

### FIELD OF THE INVENTION

This invention relates generally to simple and low cost electronic optical devices, methods and algorithms for enumeration of microscopic particles distributed in a two-dimensional plane. More specifically, the present invention relates to the adaptation of automated cell enumeration platforms for the direct detection of virus-infected cells in a fluid sample such as nasopharyngeal samples.

### BACKGROUND OF THE INVENTION

The enumeration of absolute levels of cells and their subsets in body fluids is of primary importance in determining the state of health of human beings and mammals in general. The primary analytical platform for performing such analyses is viral culture, direct immunofluorescence (DFA), or flow cytometry in which the specimen is either injected directly or after prior enrichment in rare cell analysis. Viral Culture, DFA, Flow cytometry and similar complex analytical systems remain largely inaccessible for routine clinical use in resource-poor countries due to high instrument and reagents costs, lack of technical support. There is a clear need for simpler, more compact and less expensive systems also operable with emergency DC battery power that is able to rapidly detect the presence of a virus from a biological sample.

Among the numerous clinical applications for a simple cell analyzer, the ability to capture and detect virus-infected cells present in various cell culture systems and patient samples is important. The current systems and methods for cell analysis have some significant disadvantages. They generally require sophisticated techniques, which involve the use of instruments that are expensive both in terms of initial cost and maintenance as well as requiring highly trained personnel. This makes the conventional systems unsuitable for use in mid size and small hospitals as well as laboratories of resource-poor countries. Therefore, a low-cost, easy-to-use method for cell enumeration serves as a compact alternative to the other cell analysis systems and would be suitable for physician practices, bedside testing, or in open field settings with the ability to count rare cells in each condition. U.S. application Ser. No. 10/903,798 and U.S. application Ser. No. 11/434,321 provide for a compact electronic optical instrument for the detection and enumeration of magnetically labeled target cells.

Testing paradigms for rapid viral detection which rely on antigen detection vary considerably in their sensitivity and the turn-around-time (TAT) for a result. Point of care tests (POCT) have a 15-20 min TAT and are easy to use. POCTs find utility in physician's offices, microbiology labs and in virology labs during the second and third shift. However, the sensitivity of these tests is widely reported to be low, particularly out of season. Direct specimen testing using Cytospin or smear preparations has been reported to be more sensitive but requires 60-90 min, is tedious to perform, currently lacks standardization, leads to relatively large numbers of specimens with insufficient number of cells to conduct the test (QNS>20%), and requires a medium complex lab with skilled technologists performing and interpreting the fluorescent staining results.

The devices in the aforementioned prior art are designed to image slides. None are capable of detecting and enumerating a target population within a biological specimen as defined herein. Furthermore, none appear to be portable or stand alone devices. These instruments are designed to rely on a desktop computer to control the microscope and camera, and to perform image analysis algorithms. The present invention overcomes many of the difficulties that lie in the prior art and allows for the feasibility of a rapid, semi-automated method to detect respiratory virus infected cells in direct specimens.

### SUMMARY OF THE INVENTION

This invention platform (sometimes referred to herein as “EasyCount”) describes compact electronic optical instruments, analytical methods, image acquisition, and data reduction algorithms for the detection and enumeration of magnetically or otherwise labeled target cells or particles. Using whole blood as an example, blood cells are fluorescently labeled using one or more target specific fluorescent dyes, such as a DNA staining dye. The cells of interest or target cells in a samples of blood, nasopharanx, throat, or other bodily fluids, tissues, or parts are labeled by incubation with specific binding molecules such as monoclonal antibodies conjugated to ferromagnetic particles or fluorescent molecules. The sample is then placed into an appropriate optical detection chamber or cuvet, which in turn may be placed into a magnetic field gradient that selectively causes the magnetically labeled cells to move towards the upper observation surface of the chamber; or in the case of a microscope slide, placed on a stage that positions the slide in the optical path. The target cells settle or are collected and immobilized substantially uniformly on the optically transparent surface of the chamber or slide. A segment of this surface and the labeled target cells thereon are illuminated by means of one or more LED (light emitting diodes). Subsequently, the light emitted by individual target cells is captured by a CCD (charge coupled device).

The present invention provides detection means that incorporate illumination components, filter apparatus, focusing device, software and image analysis that together provide an improved device and methods for low cost, compact electronic optical instrument.

One embodiment of the present invention, called the MagNest configuration, incorporates the magnetic manipulation of labeled cells from a sample wherein the target cells are positioned along the upper glass observation surface of a sample chamber as previously described in U.S. application Ser. No. 10/903,798 and U.S. Pat. Nos. 6,890,426 and 7,011,794. The system counts the number of cells present on the observation surface of a defined area. Since the height of the chamber and area of the observation region are known, the volume from which the cells are extracted can be determined and the number of cells present at the observation surface can be directly converted to the absolute number of cells in the sample.

Another embodiment of the present invention incorporates the use of a slide configuration whereby a slide enclosed with a cover slip having only an inlet and outlet port is positioned on the viewing stage of the cytometer so as to position all cells along a single viewing plain. A biological sample is assessed for viral infection by staining the sample with specific binding molecules, such as MAbs labeled with fluorescent compounds, so that infected cells fluoresce and uninfected cells do not fluoresce. In addition all cells are labeled with a counter stain dye such as Evans Blue, Thioflavin T, or other appropriate fluorescent agents known in the art to label cells, for example on the membrane surface or nucleus. This counter stain may be used to identify the number of all the cells in the test.

The cells are counted based on their fluorescence intensity difference with the background. The emitted fluorescence is imaged onto a CCD camera. Image analysis routines coded inside the system determine the number of cells present, and the number of cells that fluoresce as a result of a specific interaction with the specific binding molecule. The development of the algorithms for image acquisition and data reduction required considerable laborious experimentation and optimization. This resulted in the present invention configuration that exhibits the excellent performance characteristics as described herein.

Further advantages provided by this invention are the functional simplicity in design, ruggedness, compactness, AC or DC power options, and substantially lower purchase and operating costs relative to conventional commercial devices with comparable performance characteristics. The features and improvements of the devices of this invention, exemplified as compact clinical cell cytometer, make them particularly useful for operation in small, non-complex and in unsophisticated laboratories or field conditions prevalent in resource-poor countries.

A further improvement is in the individual illumination/light capture components of the cytometer. The LEDs are positioned to illuminate along the long axis of the cartridge at a mean angle of incidence of 45 degrees. The turret provides up to four wavelengths, depending on the intensity required to illuminate the specimen. The present configuration is for two different wavelengths. This ensures maximum illumination and light capture. The use of solid state illumination devices ensures that the light source will outlive the life of the instrument, providing a distinct advantage in field use. The filter changer operates through a slider crank having an eccentric bearing to align the individual filters. The slider crank is optimized for a small space and minimal expense. The preferred number of emission filters is two, but multiple filters are contemplated with the present application.

A further improvement is the elimination of an active Z-stage adjustment when imaging the target cells. Target cells are maintained in focus along the Z-plain with the incorporation of a spring loaded mechanism on the holding device that references the slide or cartridge against the position tabs (monuments) that maintains a fixed distance between the cells and objective lens. The spring support acts to apply a upward force to the cartridge/sample holder when positioned onto the holder. Accordingly, monuments come down onto the sample holder that push against the springs and force the sample to be in a pre-set plane. This eliminates variations in tolerances in the sample holder and cartridge. Thus, any need for changes in focus are eliminated along the Z-direction. A similar principle is used with the slide configuration.

It is to be understood and appreciated that these discoveries, in accordance with the invention, are only illustrative of the many additional potential applications of the apparatus, methods and algorithms that may be envisioned by one of ordinary skill in the art, and thus are not in any way intended to be limiting of the scope of the invention. Accordingly, other objects and advantages of the invention will be apparent to those skilled in the art from the following detailed description, together with the appended claims.

### BRIEF DESCRIPTION OF TIM DRAWINGS

FIG. 1. Diagrammatic representation of relevant positioning of the device components in producing the compact structure of the device. The LED turret, filter changer, microscope and camera are positioned above the sample holder and XY stage which together are juxtaposed from the touchscreen and sample door as shown.

FIG. 2: Schematic representations of optical and illumination arrangements. In (A), light from an LED is focused on the sample through a condenser, a set of filters and a 10× objective. An image of the fluorescence of the cells is projected on and captured by a to CCD camera. In (B), the light of two LED's is directly projected onto the sample.

FIG. 3: (A) Magnetic gradient in the chamber in x- and z-direction. The x-component of the gradient is negligible. (B) Magnetically labeled white blood cells move upwards in the chamber, while unlabelled red blood cells move downwards.

FIG. 4: A cross-sectional representation of the improved magnetic cartridge holder mounted on observation stage. The “spring positioning” tabs are positioned along the longitudinal axis as shown.

FIG. 5: Representation of the filter changer. An eccentric bearing positions the sliding crank, having two or more filters, in position with the light path. Microscope is removed.

### DETAILED DESCRIPTION OF TAE PREFERRED EMBODIMENTS

The technical terminology with reference to biological, clinical, electronic, mathematical and statistical expressions used herein conform to conventionally accepted definitions.

The terms “sample” or “specimen” are interchangeably used herein and refer to biological material obtained from tissue, spinal fluid, bone marrow, blood, or other sources. A sample can also include viruses, bacteria, or other pathogens. A typical example of a biological specimen would be blood drawn from a subject. As utilized herein the term “cells” refers to animal or plant cells, cellular bacteria, fungi, which are identifiable separately or in aggregates. For example, cells can be human red blood cells (RBC) and white blood cell (WBC) populations, cancer, or other abnormal cells. The terms “target” or “target population” refers herein to biological entities of interest that may be present in a biological specimen that is being analyzed. A typical example of members of a target population would be CD4 positive cells in a blood sample. Conversely, the'terms “non-target” or “non-target population” as used herein refer to entities present in a biological specimen, are not the subject of the analysis.

### System Design

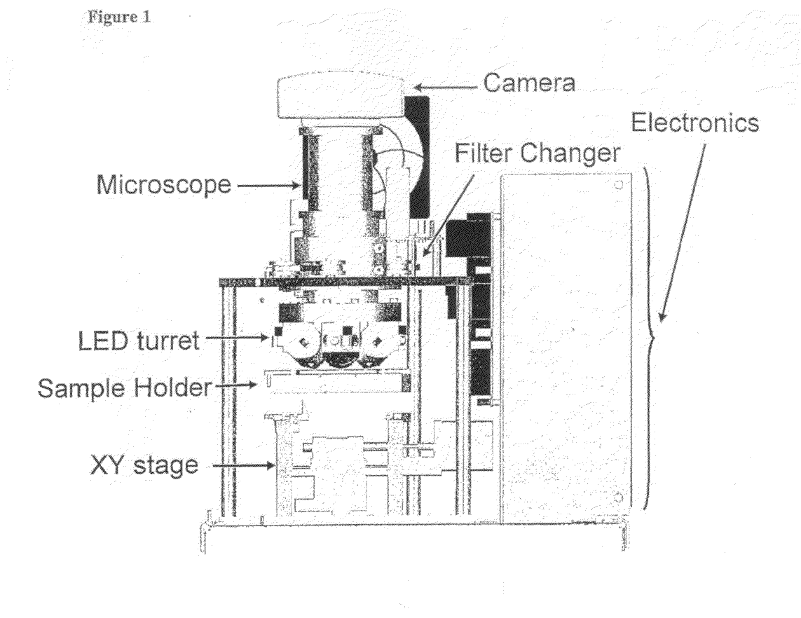

The different components of the apparatus (sometimes referred to herein by its project name, “EasyCount”) are shown in FIG. 1. The imaging part of the apparatus is based on an epi-illumination fluorescence microscope. The surface of the sample chamber is illuminated by light emitting diodes. The light emitted from the fluorescently-labeled cells at the inner surface of the chamber is collected by an objective and focused onto a CCD.

To select and separate the target cells of interest, for example, from a whole blood sample, they are immunomagnetically labeled with a target specific antibody conjugated to magnetic particles, ferrofluids or superparamagnetic particles, as disclosed in U.S. Pat. Nos. 5,579,531 and 5,698,271 and U.S. application Ser. No. 10/208,939, each of which are incorporated by reference herein. The magnetic particles are typically about 180 nm in diameter and consist of a magnetic iron oxide core surrounded by a first polymeric layer to which streptavidin is conjugated. Target-specific antibodies can then be coupled to streptavidin by means of biotinylated antibodies. However, superparamagnetic particles made from other ferromagnetic materials, for example nickel, of similar or larger sizes of up to about 5 μm, can be similarly coated and used for magnetic labeling of target cells.

Finally alternative binders, such as lectins and boronate derivatives, recognizing glycosidic receptors on target cells may also be used in lieu of or in addition to antibodies on such magnetic capture particles.

For example, if the cells of interest are the total leukocyte population, a pan-leukocyte CD45 monoclonal antibody can be used that binds substantially specifically to all leukocyte populations in the blood sample. The cell labeling reaction can be conducted in test tubes or vials and an aliquot transferred to the sample chamber. Alternatively, the chamber itself can be used for incubations of specimen volumes of up to about 200 μl. The unbound non-magnetic materials are readily removable in the supernatants after magnetic separation. To enhance magnetic labeling efficiency of target cells one can use magnetic incubation or in-field incubation (PCT/US00/02034, which is incorporated by reference herein). To accomplish this, the sample is mixed with the magnetic ferrofluid in a test tube, and placed briefly inside a quadrupole high-gradient magnetic separator (HGMS) magnet (U.S. Pat. Nos. 5,186,827; 5,466,574; 5,641.072, incorporated by reference herein) after which it is removed from the magnet and remixed by vortexing. This step is repeated twice more. The quadrupole magnet delivers a radial magnetic gradient during the incubations, thus forcing the magnetic particles to move laterally as bead chains that sweep through the sample before accumulating at the wall surface. This multiple forced migration of magnetic particles increases the probability that the magnetic particles collide with or encounter the larger, substantially immobile, cells as compared to mere diffusional or Brownian collision of the magnetic particles and the target cells in the sample. Other magnetic configurations can be used that homogenously sweep through the sample.

Alternatively, samples are stained with any agent known to stain cells (i.e. Thioflavin T, Evans Blue, etc.). The cells are counted and gives a value for the total number of cells to present. A modified microscope slide having a sealed viewing chamber, formed with a glass cover slip bonded to the surface of the slide. A chamber is formed between the cover slip and slide by molding a shape to allow partitioning of the fluid sample between an entry port and exit port. The entry port must accept a sample from a 10 ul pipette tip.

### Sample Chamber and Magnet Holder for Immunomagnetic Enrichment and Observation

When a biological specimen is to be visually analyzed, it is necessary for the target population to be adjacent to the observation surface. This allows the optical arrangement to clearly focus on the target population in order to provide an accurate analysis. Once the members of the target population have been magnetically labeled, they can be manipulated to the observation surface for visual analysis.

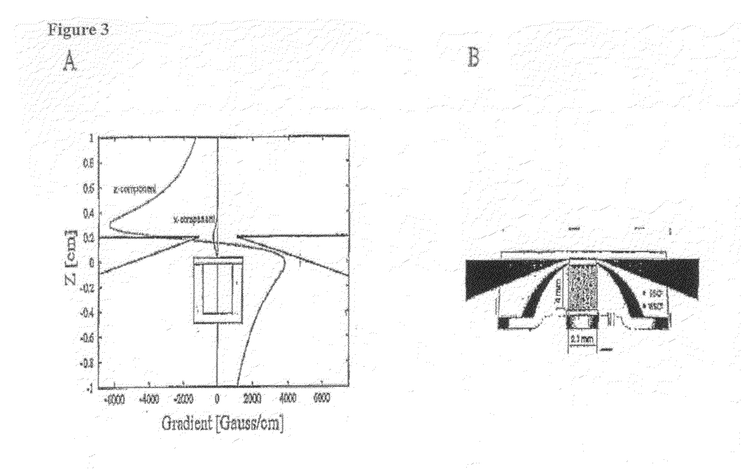

The chamber and the magnetic yoke holder have been previously described (U.S. Pat. Nos. 5,985,153; 6,136,182; PCT/US02/04124, which are each incorporated by reference herein). The chamber consists of a molded body of inner dimensions 30×2.7×4 mm, length×width×height respectively. It has an optically transparent planar top surface) that is sealable, if required, by means of a removable plug cap. The sample chamber is shown (FIG. 3) oriented in the horizontal plane for probing with a vertical light beam. However, an alternative instrument design would accommodate an uncapped detection chamber or other suitable sample cuvet with the magnetic holder oriented vertically and the light beam oriented horizontally.

The magnetic chamber holder or yoke is designed such that the chamber is positioned 2 mm below the top of two magnetic pole pieces. The pole pieces are made of Neodymium Iron Boron alloy with an internal magnetization of 13,700 Gauss (Crumax Magnetics Inc, Elizabethtown, KT). The two pieces are mounted to form a 3 mm gap between their faces that are an angled 70° relative to the z-axis. This arrangement, depicted in FIGS. 3A and B, creates a magnetic gradient inside the chamber, which is pointing in the z-direction and has a negligible component in the x-direction. Therefore, the immunomagnetically-labeled cells and unbound ferrofluid particles move in the vertical direction to the upper surface. The imaged surface area correlates directly with the volume fraction underneath the imaged area (FIG. 3B). To obtain a representative and accurate number of cells per unit volume, it is important that the cells are uniformly distributed and immobilized over the viewing surface, which requires that the magnetic field conditions also are uniform over the full area of the glass surface.

A further improvement to the magnetic arrangement described above was to “spring to load” the yoke assembly. This positions each sample cartridge into a repeatable location. Because of this, the specimens that are being analyzed are always in focus in the Z-axis as they are being imaged. This is extremely important for using the apparatus of the invention as a fast analyzer because independent focusing for each sample cartridge is no longer necessary. As the sample cartridges are manufactured with precision, the yoke assembly can position every sample to always be in focus.

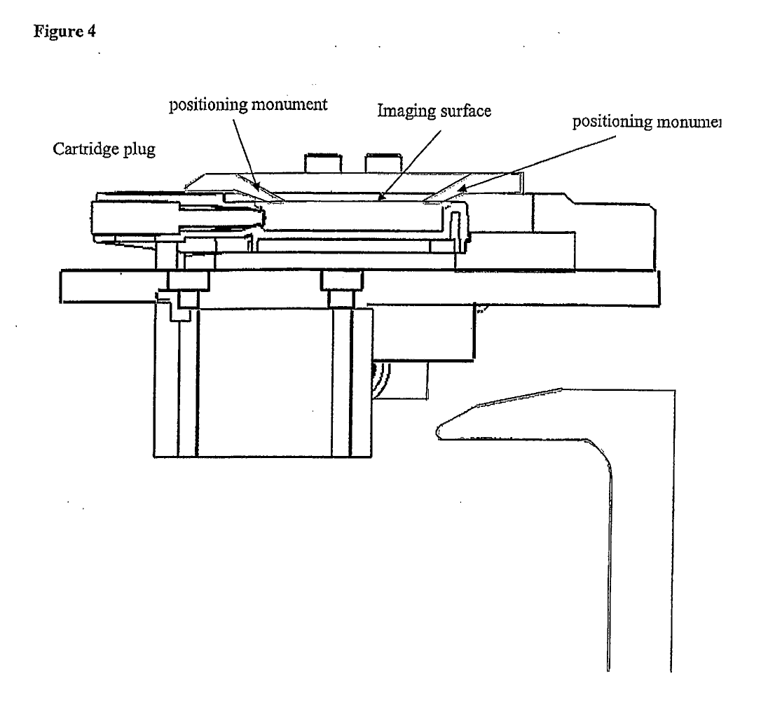

Thus, the system is further improved to include spring loaded clips to hold the chamber against the upper surface of the yoke assembly (FIG. 4). This modification removes variations in the manufacture of multiple assemblies. Accordingly, the viewing surface is consistently held in the same z-axis for observation. Any variation in the production of the assemblies is reflected on the lower portion of the yolk and does not affect the Z-axis for imaging. Thus for cell focus, no active z-stage is required as variations in yolk tolerance between is expressed on the bottom surface of the yolk.

A similar design for the modified microscope slide holder provides for no variation in the z-axis. Here, the same principle provides a “spring load” affect on the microscope slide, eliminating focusing the Z-axis.

The Imaging system

### Fluorescent Staining of Cells

In order to make the cells detectable, the sample is stained with a counter stain dye (such as Evans Blue or a vital dye) that stains the nucleus of all the cells, as well as several constituents of the cytoplasm. Other fluorescent dyes, such as Hoechst 33258, and Hoechst 33342 may be used. In general, any fluorescent dye that non-specifically stains cells, cytoplasm, cellular nucleic material, or the nucleus itself can be used. These dyes are referred to herein as “non-specific fluorescent dyes.” Cells infected with targeted viruses or other components of interest are reacted with specific binding molecules such as monoclonal antibodies labeled to fluorescent molecules that bind to the virus components on or in the cells. Also, any particle that can be attached to an antibody and detected by microscopy is considered in the present invention. The light emitted by the non-specific fluorescent dyes and that emitted by the specific binding partner may be differentiated from each other by the use of appropriate filters placed in the optical path of the instrument.

In general, illumination in fluorescence microscopy is achieved by mercury arc or quartz-halogen lamps. In some microscopy systems, more expensive lasers are used for illumination. However, recent advances in semiconductor technology have lead to the development of high-brightness light emitting diodes that can compete with incandescent light sources and lasers. The advantages of using LEDs as light source are that they are relatively compact, inexpensive, and have a long lifetime without a need to replace. The spectral power distribution of a LED is fairly narrow, with half-bandwidths of about 20 to 50 nm, depending upon the substrate material. LEDs produce highly saturated, nearly monochromatic light and are ideal for constructing the compact and inexpensive cytometer devices of this invention.

### Optics

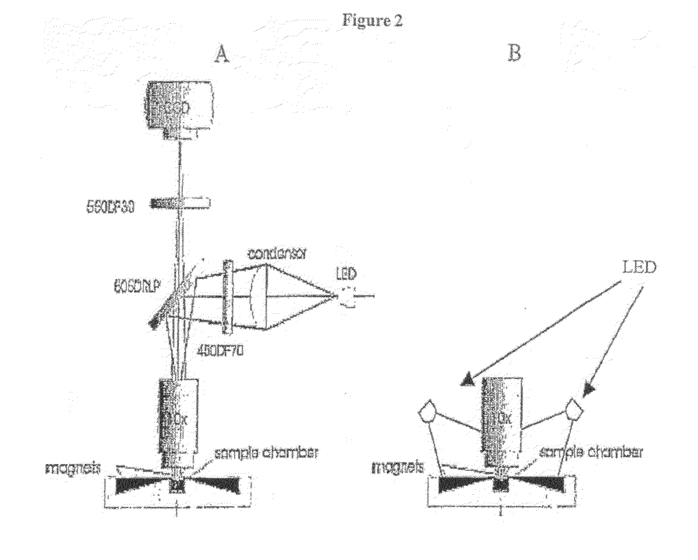

The light from an LED is collected by a condenser lens with a focal distance of 27 mm, passes a short pass optical filter, focused at the sample plane. This optical configuration results in a homogeneous illumination of the sample area. The light emitted from the fluorescent cells collected at the underside of the glass surface of the chamber, or settled onto the lower surface of a glass slide, is collected the objective (1-20X, NA 0.03-0.25), after which it is filtered by a band-pass or long pass filter and focused onto a high QE, high bit resolution (minimum 12 bits) CCD camera (DSI, Meade Instruments Corporation, Irvine, Calif.). FIG. 2A shows the conventional epi-illumination mode. FIG. 2B shows a direct side illumination of the viewing surface with one or more LEDs in a “floodlight” arrangement, which provides sufficient excitation energy, and may be a simpler and less expensive illumination mode.

The present invention improves upon the orientation of the LED with respect to the slide and cartridge cell alignment. LED's are aligned along the longitudinal axis of the cartridge, ensuring maximum light intensity. FIG. 4 depicts the advantage of orientating the components in a small area using a fixed distance between the specimen and objective lens

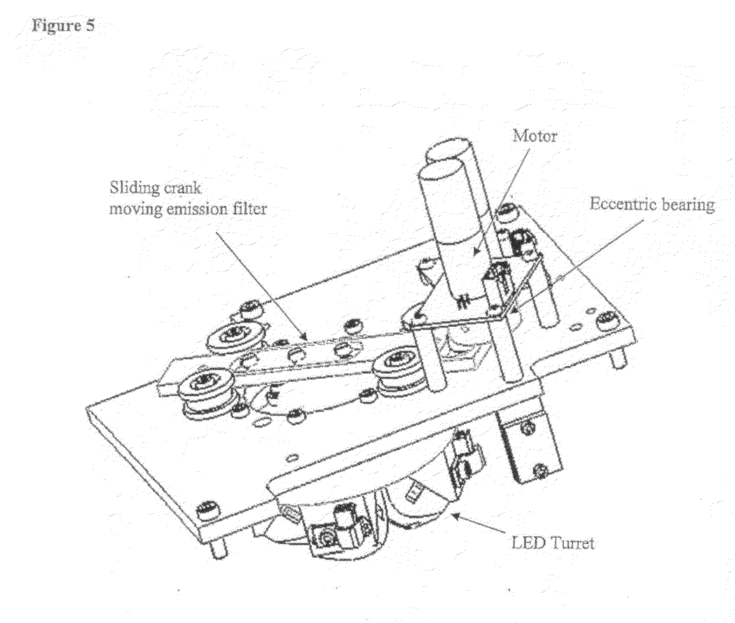

In addition, the present invention improves upon the positioning of the filter assembly. FIG. 5 shows a general orientation of the emission filter set positioned in EasyCount. The filter changer is a sliding crank with an eccentric bearing to position the filter. This orientation provides for an inexpensive and compact device for switching between two or more filters.

### Camera

The CCD used in this set-up (DSI, Meade Instruments Corporation, Irvine, Calif.) where the image is retrieved from the camera by software and stored in a computer memory as 12/16-bit TIF images.

### Image Processing and Analysis

Algorithms were developed to count the cells in the images obtained from the optical system. First, a model is presented to describe the cell images. Then, a method for spot detection in the images is introduced. Cells are enumerated based on size, intensity, uniformity, aspect ratio, etc.

### Example 1

### Detection of Virus-Infected Cells Using Rare Cell Analysis

Objective; We studied an adapted cell detection technology, originally developed to detect ultra-rare tumor cells in circulation, to capture and detect virus-infected cells present in various cell culture systems and patient NP samples.
Relevance: Clinical diagnosis of viral infection often involves direct specimen analysis using Direct Fluorescent Antibody (DFA) followed by virus culture in susceptible cell lines. DFA is faster but is labor intensive, provides a subjective result and is not as sensitive as culture or molecular methods that may require 6 to 48 hrs for a result.
Methodology: Virus culture was done using standard methods using A549, Mink Lung, SKBr-3, and RMix (DHI) as susceptible host cell lines. Ferrofluids (FF) were prepared as colloidal suspensions of 200 nM magnetic particles coated with antibodies to specific antigen targets on cells. Suspensions of cells were fixed with cell fixative solution, washed, incubated for 10 min with PE-labeled detection antibodies, DAPI, and FF, and then placed in a MagNest (Immunicon) for 10 min to affect magnetic mounting of the immuno-selected cells. Cells were imaged on a CellTracks Analyzer II, a four color fluorescence imaging system. For sensitivity comparisons and “dose response” studies, cultured cells with infected Influenza A, were fixed and serially diluted in buffer.
Validation: Flow cytometric analysis showed cultured cell'lines and NP cells expressed the epithelial antigens Ep-CAM, Cytokeratin (CK), and MUC-1 on both virus-infected (adenovirus and influenza virus) and uninfected cells. These antigens were exploited in cell capture for detecting infected cells. Cells infected with Influenza A were captured using anti-CK FF and detected using anti-Influenza-A-FITC (anti-Flu A). At high concentrations of infected cells, 513 of 803 spiked cells were captured and at low cell numbers where samples contained 3.1, 1.6, or 0.8 cells, 3, 0, and 1 cell respectively were detected. Similar results were seen when virally infected cells were spiked into UTM containing uninfected NP cells. Infected cells could also be captured using virally specific FF. Cultures were infected with influenza A or B at various M.O.I. Cells were harvested 4, 6, 8, and 22 hours post infection, fixed, stained and captured using anti-Flu A or anti-Flu B FF. Virus positive cells could be detected in as little as 6 hours post infection.
Conclusions: This study showed that cells of epithelial origin may be captured and probed for the presence of virus. Cells were captured using either cellular or virus-specific antigens as targets for enrichment. The combination of efficient magnetic enrichment and virus-specific antibody detection in EasyCount, a less expensive, robust 2-color imaging instrument suitable for clinical chemistry labs may lead to the development of a rapid and simple virus detection method for sensitive and specific direct detection of infected cells in NP samples and potentially serve as a rapid diagnostic platform for additional sources of epithelial-based virus infections.

### Example 2

### Feasibility Study of a Rapid, Semi-Automated Method to Detect Respiratory Virus Infected Cells in Direct Specimens

Objective: The objective of this study was to demonstrate that a rapid, liquid specimen processing procedure could readily differentiate positive and negative cell culture in <2 min using EasyCount™, an automated fluorescent microscope with cell counting capability. EasyCount™ uses a CCD camera to visualize counter stained cells for a total cell count and interrogates those same cells to identify those that are infected with virus by detecting fluorescein.
Methods: We chose R-Mix and Influenza A (Flu) as a prototype cell culture/virus system to simulate a direct specimen scenario for automated detection purposes. Flu virus was inoculated in duplicate onto 24-well R-Mix plates, centrifuged at 700×g for 60 min, and incubated at 37° C. for 20 hr. One plate was fixed, stained and counted to confirm the viral input. The cells from the replicate plate were released and cells pelleted by centrifugation and the supernatant removed. The cell pellets were then stained for 15 min at 37° C. with reagent containing Evans Blue and Flu specific, FITC-labeled monoclonal antibodies. The cells were then washed, resuspended in PBS, and a 10 μL aliquot of the stained cell suspension was transferred into individual wells of a counting slide and the slide was placed into EasyCount™ (Immunicon Corp.). Each well was counted for 1 min.
Results: The total cells counted (n=3 fields) in EasyCount™ for each level of Flu was between 2,190-2,380, approximately 10-20 times more cells than the minimum required to report a negative result with Cytospin. Mock-infected cells showed no detectable infected cells in the cells counted. The efficiency of detecting virus infected cells was high, ranging from 55-100% depending on infectious dose.
Conclusion: Liquid processing of virus-infected cells can be used to produce a good MAb staining reaction in 15 minutes, furthermore, EasyCount™ provided a specific, sensitive and, importantly, objective determination of a) total cell counts, and b) Flu infectivity in a 1 minute per sample read time. Further studies will focus on adapting EasyCount™ with a rapid liquid processing format using clinical respiratory specimens.

While certain of the preferred embodiments of the present invention have been described and specifically exemplified above, it is not intended that the invention be limited to such embodiments. Various modification may be made thereto without departing from the spirit of the present invention, the full scope of the improvements are delineated in the following claims.

What we claim is:

1. An method for detecting and enumerating a target population suspected of a viral infection within a biological specimen comprising:
a. obtaining said biological specimen from a subject;
b. contacting with a capture agent linked to ferrofluid particles that binds to a target-specific site on said target population;
c. isolating said labeled cell population by immunomagnetic capture;
d. labeling a viral-infected subpopulation of said target population with a secondary agent linked to a fluorophore wherein said secondary agent is specific for the infecting virus;
e. detecting said infected subpopulation;
f. acquiring an image of said cell population; and
g. analyzing said image to detect and enumerate said subpopulation.

2. The method of claim 1 wherein said target population is a cell population.

3. The method of claim 1 wherein said biological specimen is a nasopharengeal or throat swab.

4. The method of claim 2 wherein said agent is from a group consisting of an antibody, a carbohydrate, lectins, hemolymph proteins and nucleotide sequence.

5. The method of claim 2 wherein said target site is epithelial antigen.

6. The method of claim 1 wherein said viral infection is Influenza-A or adenovirus.

7. The method of claim 1 wherein said analyzing is obtained from a CellTracks Analyzer II system.

8. The method of claim 1 wherein said analyzing is obtained from EasyCount.

9. An method for detecting and enumerating a target population suspected of a viral infection within a biological specimen comprising:
a. obtaining said biological specimen from a subject;
b. contacting said target population within said biological specimen with an viral specific monoclonal antibody linked to a fluorophore;
c. staining proteins within said target population;
d. acquiring an image of said target population; and
e. analyzing said image to detect and enumerate said labeled cell population.

10. The method of claim 9 wherein said target population is a cell population.

11. The method of claim 9 wherein biological sample is a nasopharengeal or throat swab.

12. The method of claim 9 wherein said viral infection is Flu.

13. The method of claim 9 wherein said stein is Evans Blue.

14. The method of claim 9 wherein said analyzing is with EasyCount.
